(19) United States
(12) Patent Application Publication
(10) Pub. No.: US 2006/0014578 A1
(43) Pub. Date: Jan. 19, 2006

(54) Daily picks game

(76) Inventor: John G. Lovell SR., Knoxville, TN (US)

Correspondence Address: PITTS AND BRITTIAN P C, P O BOX 51295, KNOXVILLE, TN, 37950-1295, US

(21) Appl. No.: 10/891,889

(22) Filed: Jul. 15, 2004

(51) Int. Cl. G06F 19/00; G06F 17/00

(52) U.S. Cl. 463/17

(57) ABSTRACT

A method for identifying a winning lottery ticket from a pool of purchased lottery tickets includes identifying a first lottery game using a series of X selected numbers, identifying a second lottery game using a series of Y selected numbers, applying to each purchased lottery game ticket a series of Z selected numbers and combining all or a portion of the winning numbers from the first lottery game with all or a portion of the winning numbers from the second lottery game to define the selected numbers for the winning lottery ticket.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains to lottery games.

More particularly, this invention pertains to lottery games which use numbers identified for a plurality of other games to identify a winner.

2. Description of the Related Art

There are many lottery games in which a player purchases a game ticket with a series of numbers selected from a larger pool of numbers. The numbers include a series of numbers having a range about 3 to 6 numbers in each series. For each game the specific number, e.g. 3, 4, 5, or 6, of selected numbers are selected from the pool of numbers. Any purchaser who has a ticket matching the selected numbers is eligible for a prize. Accordingly, there is a separate selection process for every game.

The lottery games are often televised so that a large portion of the players have the opportunity to watch the game as the numbers are selected. However, each game takes time and television time is costly. Accordingly, the number of games that can be run daily is limited. Commonly, state lotteries provide (1) a daily game with three number selections, each selected from the numbers 0-9 and (2) a daily game with four selections, each selected from the numbers 0-9. The payouts on these games are relatively low because the odds of winning are approximately 1:1000 and 1:10,000, respectively. In contrast, the payouts on the games selecting five, six or seven numbers can be much higher because the odds are approximately 1:100,000 and 1:1,000,000 and 1:10,000,000, respectively.

### BRIEF SUMMARY OF THE INVENTION

Generally, in accordance with the present invention, a method for identifying a winning lottery ticket from a pool of purchased lottery tickets comprises identifying a first lottery game using a series of X selected numbers, identifying a second lottery game using a series of Y selected numbers, applying to each purchased lottery game ticket a series of Z selected numbers and using all or a portion of the winning numbers from the first lottery game and/or all or a portion of the winning numbers from the second lottery game to define the selected numbers for the winning lottery ticket.

According to one embodiment of the present invention, a lottery game includes tickets, each of which is provided with a number of selections which exceeds the number of selections of a first lottery game. The winning combination for the pool of game tickets combines the selected numbers from the first lottery game and one or more of the numbers selected in a second lottery game. Prizes are awarded for having all of the selected numbers in exact same order and lesser prizes are awarded for having all the selected numbers in any order.

Another embodiment provides a plurality of winning combinations by combining first the selected numbers from a first lottery game with one number from a second lottery game, then the selected numbers from a first lottery game and two numbers from a second lottery game. Prizes are awarded for having all of the selected numbers in exact same order and lesser prizes are awarded for having all the selected numbers in any order.

Still another embodiment of the present invention provides a plurality of winning combinations by using won or more, but not all, of the numbers from a first lottery game.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a diagram of a game ticket in accordance with the present invention.

FIG. 2 is a diagram of an alternative embodiment of a game ticket in accordance with the present invention.

FIG. 3 is a diagram of another alternative embodiment of a game ticket in accordance with the present invention.

### DETAILED DESCRIPTION OF THE INVENTION

In one embodiment of the present invention, a lottery game includes a plurality of tickets, each of which is purchased by a player. Each ticket 8 includes a series of numbers, and the specific ticket shows a series of seven numbers. The numbers may be specifically selected by the player or randomly selected, as by a computer. The seven numbers are divided into two groups, one group of three and one group of four.

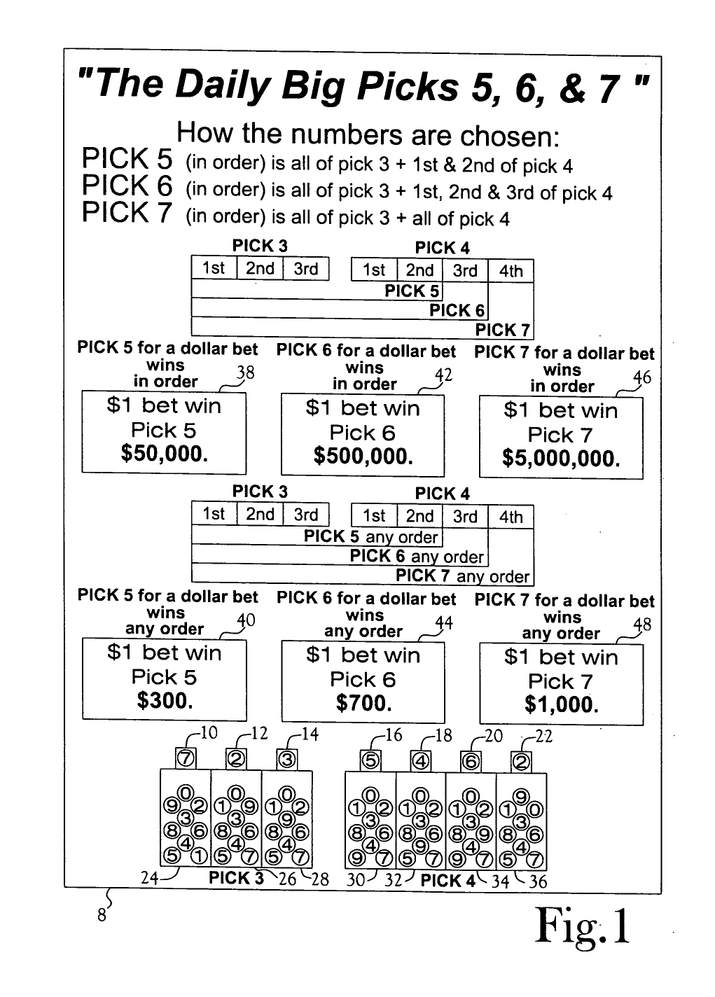

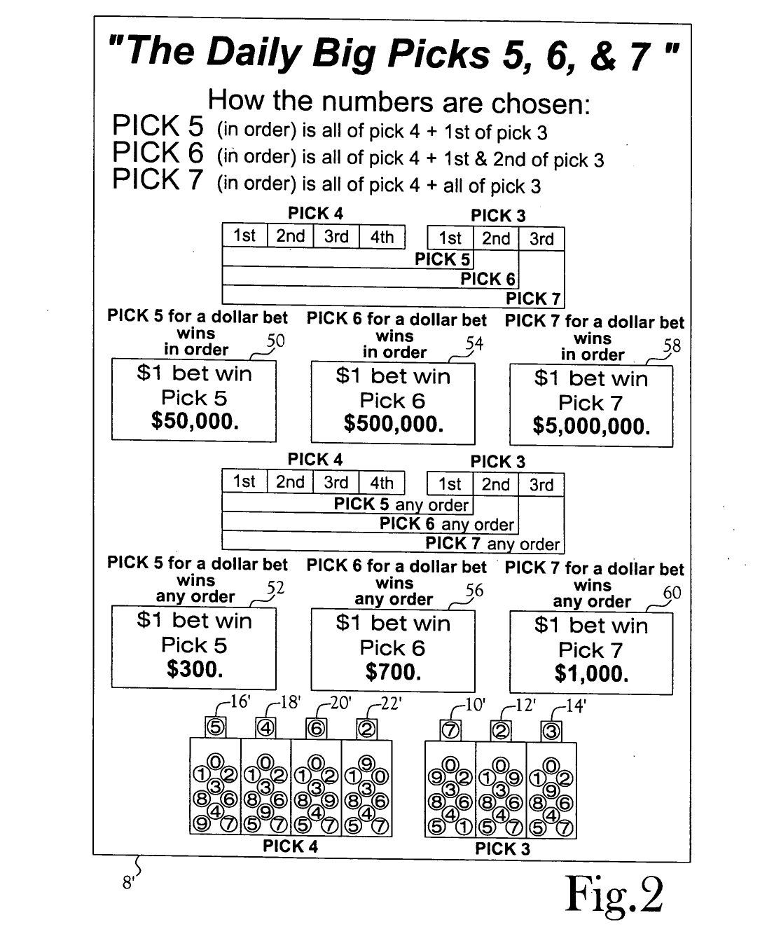

Referring to FIG. 1, the ticket 8 includes a group of three numbers, each selected from the numbers 0-9, listed in blocks 10, 12 and 14. A group of four numbers, each selected from the numbers 0-9, is listed in blocks 16, 18, 20 and 22, to the right of the group of three numbers. Adjacent to each of the blocks 10, 12, 14, 16, 18, 20 and 22, in blocks 24, 26, 28, 30, 32, 34 and 36, respectively, is a listing of the numbers not selected for the respective sequence. This listing provides an additional level of security against tampering. Referring to FIG. 2, on the ticket 8′ the group of three numbers, 10′, 12′ and 14′ are located to the right of the group of four numbers 16′, 18′, 20′ and 22′. Otherwise, the tickets 8 and 8′ are substantially identical.

The ticket 8 includes three separate games, each of which can be won in two different ways. The first game of the ticket 8, identified as PICK 5, compares the first five numbers of the purchased ticket, located in blocks 10, 12, 14, 16 and 18, to all of the numbers of a first lottery game that includes three numbers and the first two numbers of a second lottery game that includes four numbers. If the numbers are identical and they are arranged in an identical order, the prize is identified in the block 38. If the numbers are identical but are arranged in a different order, the prize is identified in the block 40.

The second game of the ticket 8, identified as PICK 6, compares the first six numbers of the purchased ticket, located in blocks 10, 12, 14, 16, 18 and 20, to all of the numbers of a first lottery game that includes three numbers and the first three numbers of a second lottery game that includes four numbers. If the numbers are identical and they are arranged in an identical order, the prize is identified in the block 42. If the numbers are identical but are arranged in a different order, the prize is identified in the block 44.

The third game of the ticket 8, identified as PICK 7, compares the seven numbers of the purchased ticket, located in blocks 10, 12, 14, 16, 18, 20 and 22, to all of the numbers of a first lottery game that includes three numbers and all of the numbers of a second lottery game that includes four numbers. If the numbers are identical and they are arranged in an identical order, the prize is identified in the block 46. If the numbers are identical but are arranged in a different order, the prize is identified in the block 48.

Referring to FIG. 2, the ticket 8′ includes three separate games, each of which can be won in two different ways. The first game of the ticket 8′, identified as PICK 5, compares the first five numbers of the purchased ticket, located in blocks 16′, 18′, 20′, 22′ and 10′, to all of the numbers of a first lottery game that includes four numbers and the first number of a second lottery game that includes three numbers. If the numbers are identical and they are arranged in an identical order, the prize is identified in the block 50. If the numbers are identical but are arranged in a different order, the prize is identified in the block 52.

The second game of the ticket 8′, identified as PICK 6, compares the first six numbers of the purchased ticket, located in blocks 16′, 18′, 20′, 22′, 10′ and 12′, to all of the numbers of a first lottery game that includes four numbers and the first two numbers of a second lottery game that includes three numbers. If the numbers are identical and they are arranged in an identical order, the prize is identified in the block 54. If the numbers are identical but are arranged in a different order, the prize is identified in the block 56.

The third game of the ticket 8′, identified as PICK 7, compares all seven numbers of the purchased ticket, located in blocks 16′, 18′, 20′, 22′, 10′, 12′ and 14′, to all of the numbers of a first lottery game that includes four numbers and all of the numbers of a second lottery game that includes three numbers. If the numbers are identical and they are arranged in an identical order, the prize is identified in the block 58. If the numbers are identical but are arranged in a different order, the prize is identified in the block 60.

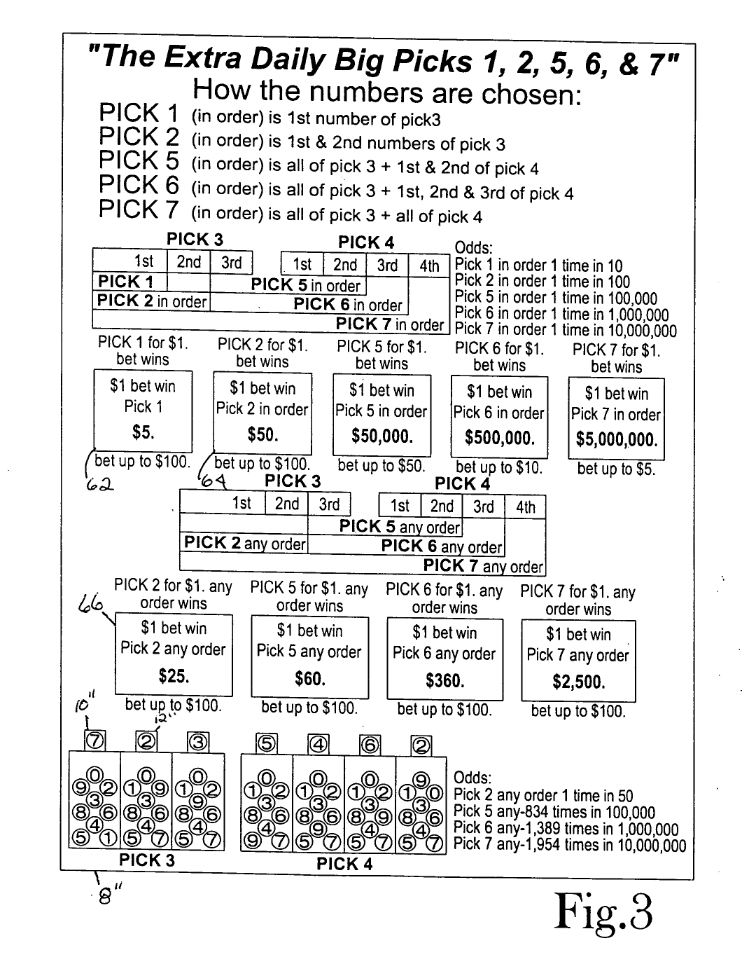

Referring to FIG. 3, an embodiment that includes five separate games, the PICK 5, PICK 6 and PICK 7 games are similarly provided as in FIG. 1. In addition, PICK 1 and PICK 2 games are provided. PICK 1 compares the first number of the purchased ticket, located in block 10″ to the first number of a first lottery game that includes three numbers. If the numbers are identical, the prize is identified in the block 62.

PICK 2, compares the first two numbers of the purchased ticket, located in blocks 10″ and 12″, to the first two numbers of a first lottery game that includes three numbers. If the numbers are identical and they are arranged in an identical order, the prize is identified in the block 64. If the numbers are identical but are arranged in a different order, the prize is identified in the block 66.

Those skilled in the art will recognize that the particular number of numbers selected from each of the first lottery game and second lottery game may be varied, as well as the order is which they are applied without departing from the spirit and scope of the present invention.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, we claim:

1. A method for identifying a winning lottery ticket from a pool of purchased lottery tickets comprising:
identifying a first lottery game using a series of X selected numbers;
identifying a second lottery game using a series of Y selected numbers;
applying to each purchased lottery game ticket a series of Z selected numbers; and
combining all or a portion of the winning numbers from said first lottery game with all or a portion of the winning numbers from said second lottery game to define the selected numbers for said winning lottery ticket.

2. The method of claim 1 wherein X equals three.

3. The method of claim 1 wherein Y equals four.

4. The method of claim 1 wherein Z is selected from the group of numbers five, six and seven.

5. The method of claim 1 wherein said selected numbers for said winning ticket are arranged in any order.

6. The method of claim 1 wherein said selected numbers for said winning ticket are arranged in the same order as all of the selected numbers in said first lottery game and a portion or all of the selected number of said second lottery game.

7. The method of claim 1 wherein said selected numbers for said winning ticket are arranged in the same order as all of the selected numbers in said first lottery game and all of the selected numbers of said second lottery game.

8. A method for identifying a winning lottery ticket from a pool of purchased lottery tickets comprising:
identifying a first lottery game using a series of X selected numbers;
identifying a second lottery game using a series of Y selected numbers;
applying to each purchased lottery game ticket a series of Z selected numbers; and
using fewer than all of the winning numbers from said first lottery game to define the selected numbers for said winning lottery ticket.

9. The method of claim 8 wherein X equals three.

10. The method of claim 8 wherein Y equals four.

11. The method of claim 8 wherein Z is selected from the group of numbers five, six and seven.

12. The method of claim 8 wherein said selected numbers for said winning ticket are arranged in any order.

13. The method of claim 8 wherein said selected numbers for said winning ticket are arranged in the same order as said selected numbers in said first lottery game.
